(19) United States
(12) Patent Application Publication
(10) Pub. No.: US 2004/0085579 A1
(43) Pub. Date: May 6, 2004

(54) Predefined field command structure for point of sale printer

(76) Inventors: Terrence J. Campbell, Ithaca, NY (US); Andrew Kobziar, Ithaca, NY (US); Andrew B. Nye III, Skaneateles, NY (US); John E. Tarbotton, Ithaca, NY (US)

Correspondence Address: HANCOCK & ESTABROOK, LLP, 1500 MONY Tower I, PO Box 4976, Syracuse, NY, 13221-4976, US

(21) Appl. No.: 10/289,496

(22) Filed: Nov. 6, 2002

(51) Int. Cl. G06K 1/00; G06F 15/00

(52) U.S. Cl. 358/1.18; 358/1.5; 358/1.9

(57) ABSTRACT

The present invention uses the capabilities provided by configuring linked command sequences to provide for logo headers, logo trailers, watermarks, and margin message logos as configuration options. Additionally, the ability to map existing text attributes to new sets of attributes that may include color is also provided.

### CROSS-REFERENCE TO RELATED APPLICATION

The present application claims priority to U.S. Provisional Application Ser. No. 60/377,805, filed Nov. 5, 2001.

### BACKGROUND OF THE INVENTION

The present invention generally relates to transaction printers, such as point of sale (“POS”) printers, and more particularly to controlling printer operations to provide a variety of additional fields to the standard text fields common to all transaction printer outputs, and adding the option of printing in a variety of colors. Transaction printers may be referred to herein as POS printers, it being understood that the present invention relates to printers that print customer transaction data, most typically a receipt after a purchase.

The ability to invoke new printer features and functions with minimal or no alteration of the existing host applications has been a long-standing desire of POS printer manufacturers. Until now, new POS printer technological advances could not be delivered to end customers without modification of the host applications.

For example, the introduction of inexpensive thermal color printing to POS devices has opened a cost-effective way for retailers to use sales receipts for marketing and fraud deterrence purposes. Because new functions are provided through new and/or extended commands, current usage would require modification of driving host application(s), something that is quite costly and potentially error prone.

The cost of upgrading legacy applications is an important, if not crucial impediment to a POS system suppliers' decision to buy new printer models or to switch printer brands. Minimizing and eliminating this cost by providing ways to use new features without major application upgrade is a desired competitive sales advantage for any POS printer manufacturer.

POS printer buyers require considerable motivation to take currently working applications and invest in upgrading them to use new POS printer features. Even if the cost of the new features is low, the hurdle that an innovative POS printer manufacturer must overcome is in cost-justifying the changes for usage of any new feature.

An example of such new features is the advent of two-color POS printers and inexpensive two-color thermal paper, made available to users via a set of new commands. The state of the art for utilization of new color commands requires enhancing applications to issue those commands. Without the application change, the new features are of little immediate value to the POS system supplier. Finding a way to make use of several new features without application change is the challenging problem to be solved.

It is therefore a principal object and advantage of the present invention to provide a transaction printer method and system that uses several new printing features without having to change the application.

It is a further object and advantage of the present invention to provide a transaction printer method and system that includes certain intelligent pre-printing of receipts.

A further object and advantage of the present invention is to provide a transaction printer method and system that permits continued usage when application changes are made.

It is yet an additional object and advantage of the present invention to provide a transaction printer method and system that permits customization of printed receipts.

Other objects and advantages of the present invention will in part be obvious and in part appear hereinafter.

### SUMMARY OF THE INVENTION

In accordance with the foregoing objects and advantages the present invention provides a transaction printer method and system, wherein the user may set up the printer using selected commands to cause the output of the printer to produce a predetermined array of data in addition to the unique text that is produced as a result of each transaction. There is no need to upgrade the host or applications in order to implement the method and system of the present invention, as the functionality is configured in firmware resident in the printer with the new features being triggered by existing commands used to print and cut receipts. The present invention is achieved with two printer functions:

1. Linking together new features that are amenable to be on at all the times to existing commands that the application already issues, and having these commands act as triggers for the linked strings of new ones.

2. Mapping text attributes from one set that the application already uses to another set that contains features not previously available to the application.

This invention is disclosed as specific collection of commands and adds the feature of making this usage a transaction printer configuration option, although other commands and options could be added without departing from the spirit and scope of the present invention. The present invention embellishes every receipt (printer output) with a predetermined header, and/or trailer, and/or with watermarks positioned in overlying relation to transaction text, and/or margin messages (i.e., side margin message logos) non-interferingly merged into the body of every printer output (typically a receipt). While the description is given in terms of a receipt, the effects described here apply to all printouts that are separated by existing printer commands such as knife cuts, or other known separation technique.

Two configuration commands are defined; the first gives the ability to have a header and footer logo designated for a receipt, with watermark and side “margin message” also merged in the body of a receipt. Whenever a knife-cut (separator) command (it should be pointed out that the present commands could be triggered by other conventional commands as well) is issued by the (old) application, a trailer logo is printed before the cut, then the cut is executed. A header logo is then printed at the top of the next receipt (assuming the header configuration is enabled). This process is followed by turning on the watermark mode and margin message mode (assuming all configuration options were on).

The second configuration option allows for mapping of up to two text attribute groups into new ones. A text attribute group is any combination of one or more text qualifiers, for example: bold, color, or italics. Using this mapping feature, the printer is able to add or replace a text attribute group with a different attribute group that may not be available from the old application. (Of course, as many attributes groups as desired could be remapped without departing from the spirit and scope of the present invention, but mapping two attribute groups is described herein).

These commands are implemented in firmware and are available for set-up application use. A Windows utility to make the setup choices easy is an obvious addition to POS system developer tools to further lessen the costs of adoption. Of course, the present invention could be implemented on any currently known transaction printer platforms.

### BRIEF DESCRIPTION OF THE DRAWINGS

The present invention will be more fully understood and appreciated by reading the following Detailed Description in conjunction with the accompanying drawings, in which:

FIG. 1 is a block diagram schematically illustrating a transaction printer;

FIG. 2 is a plan view of a receipt showing where the various command fields are printed;

FIG. 3 is a plan view of a sample receipt having the various command fields printed thereon;

FIG. 4 is a high level flow chart logically illustrating the process of the present invention;

FIG. 5 is an intermediate level flow chart of the present invention; and

FIGS. 6-18 are intermediate level flow charts of the various command and configuration processes associated with the present invention.

### DETAILED DESCRIPTION

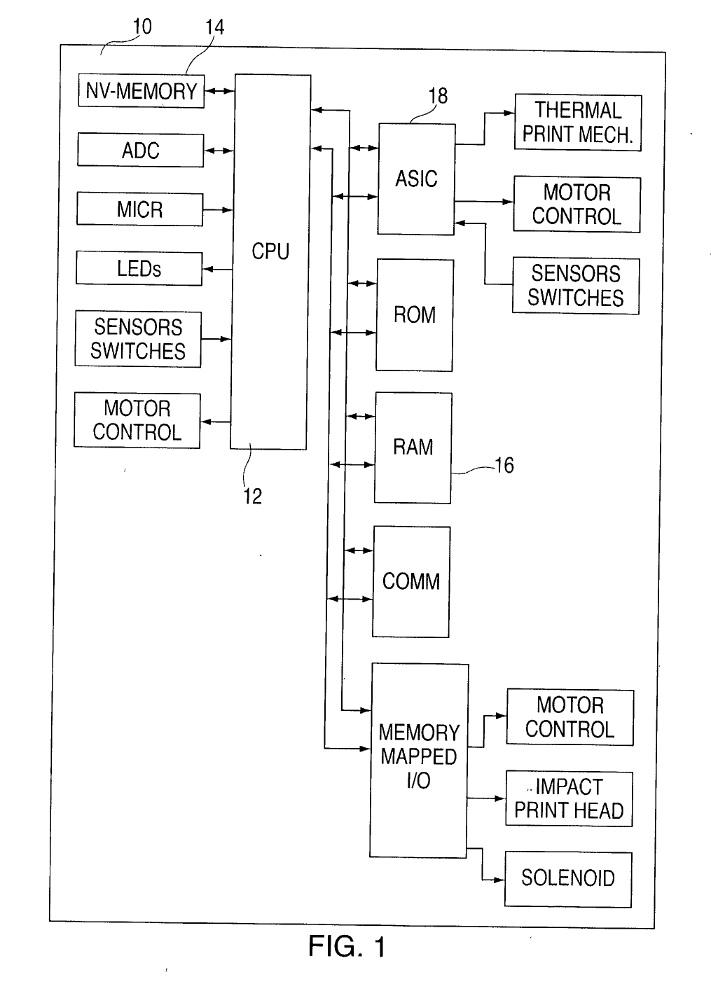

Referring now to the drawing figures, wherein like reference numerals refer to like parts throughout, there is seen in FIG. 1 a schematic illustration of a transaction printer 10. Printer 10 contains conventional electronics including a processor 12, a non-volatile memory 14, such as an EEPROM or Flash memory (or any equivalent non-volatile memory source), a memory 16 in which transaction data may be received, and an i/o mapping memory 18 from which data can be sent to the print head 20. The remaining components illustrated in FIG. 1 are well known to one skilled in the art, but are unimportant relative to the present invention.

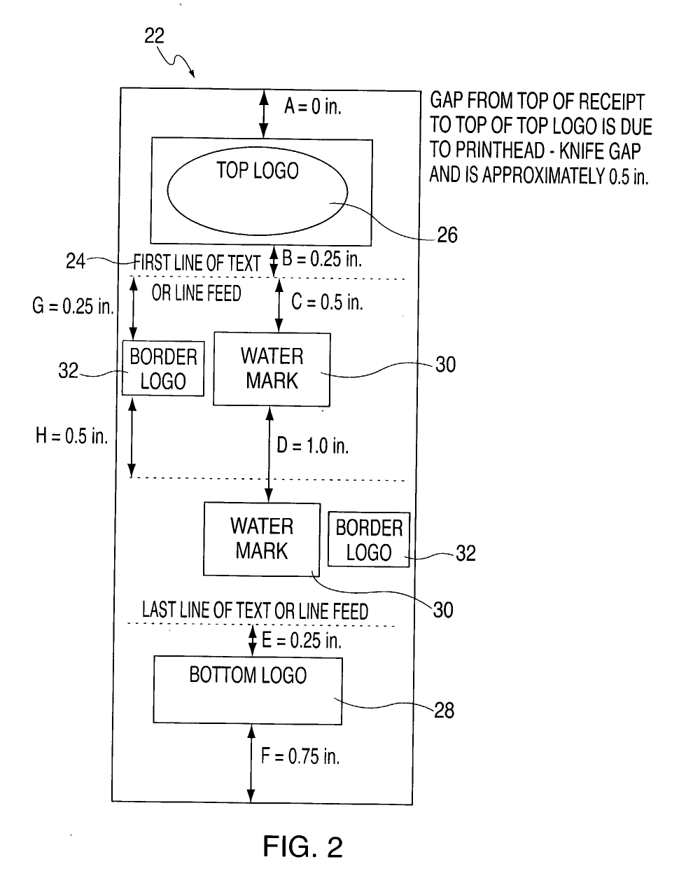

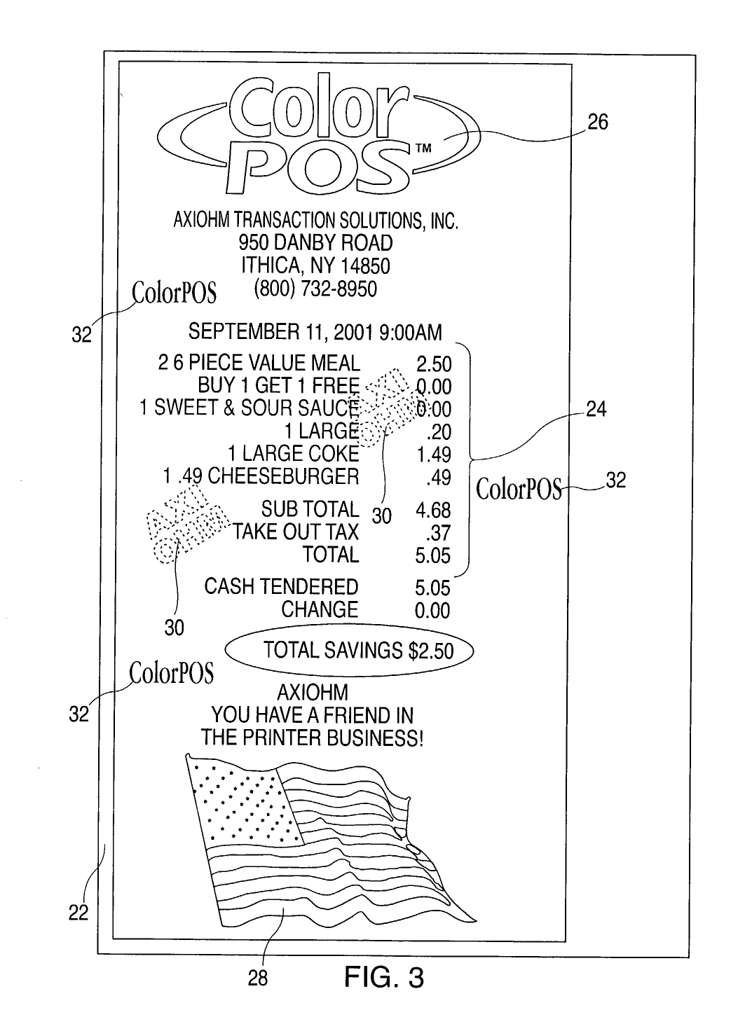

Printer 10 built in accordance with the present invention can produce receipts, such as the one generally illustrated in FIGS. 2 and 3 and identified generally by reference numeral 22. Receipt 22 contains transaction text 24, a header logo 26, a trailer logo 28, a watermark 30, and margin messages 32 positioned along the sides of receipt 22. The functions of adding header 26, trailer 28, watermark 30 and margin messages 32, in addition to substituting certain predefined attributes for original attributes in the text (i.e., when a “bold text” command is sent, substitute a “print in red ink” command therefor), are enabled by firmware embedded with an instruction set and housed within printer 10 (such as in non-volatile memory 14), as explained in greater detail hereinafter.

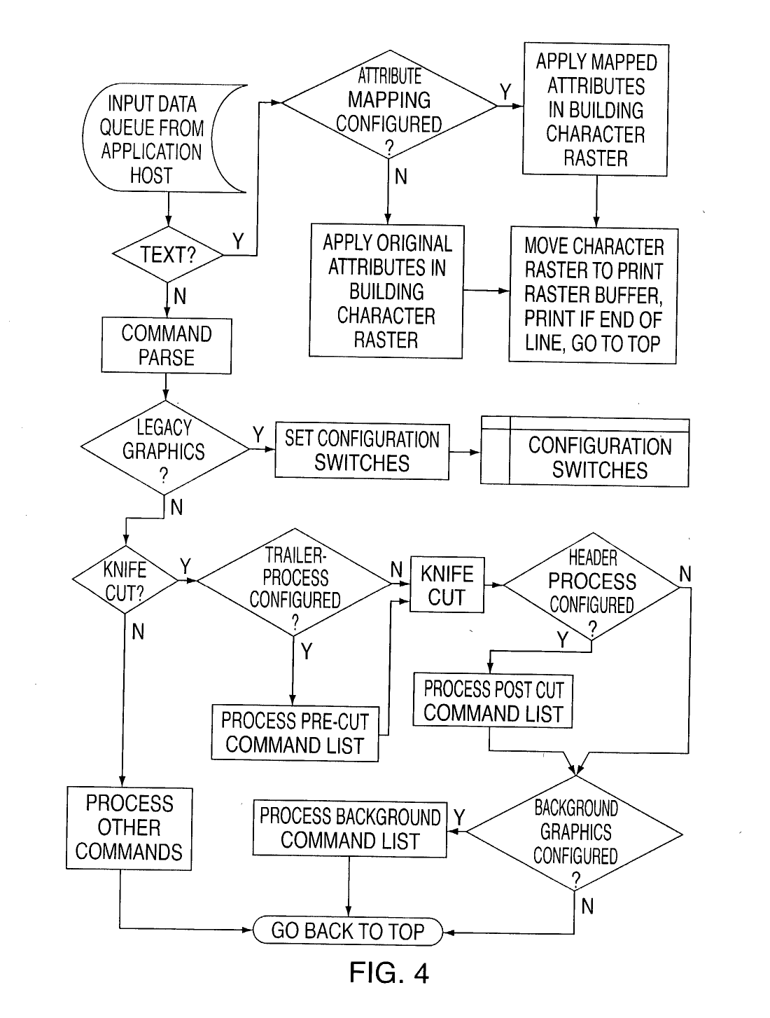

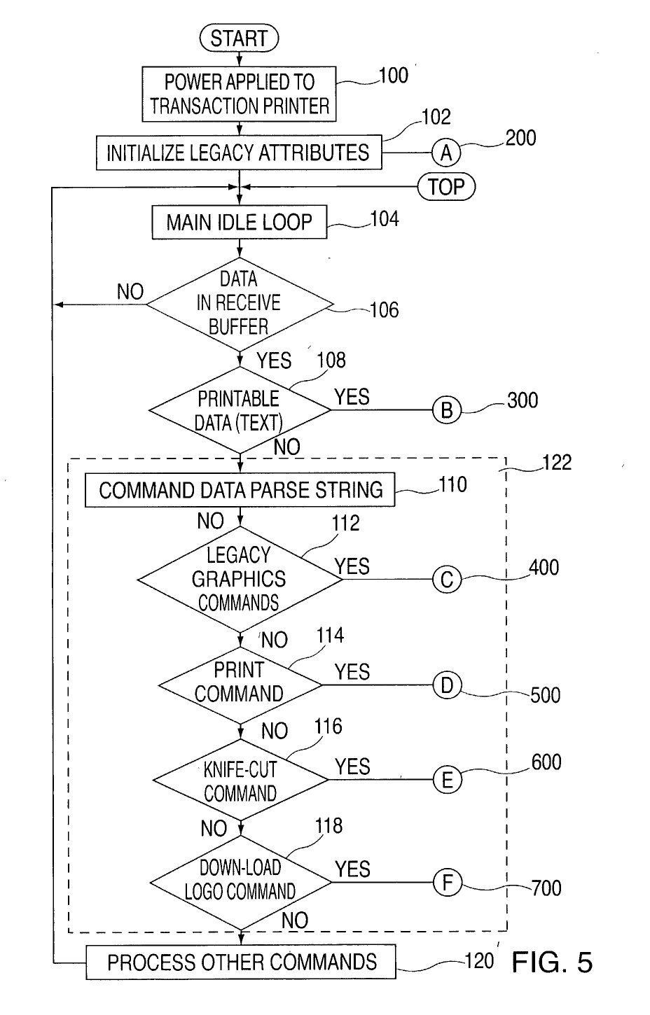

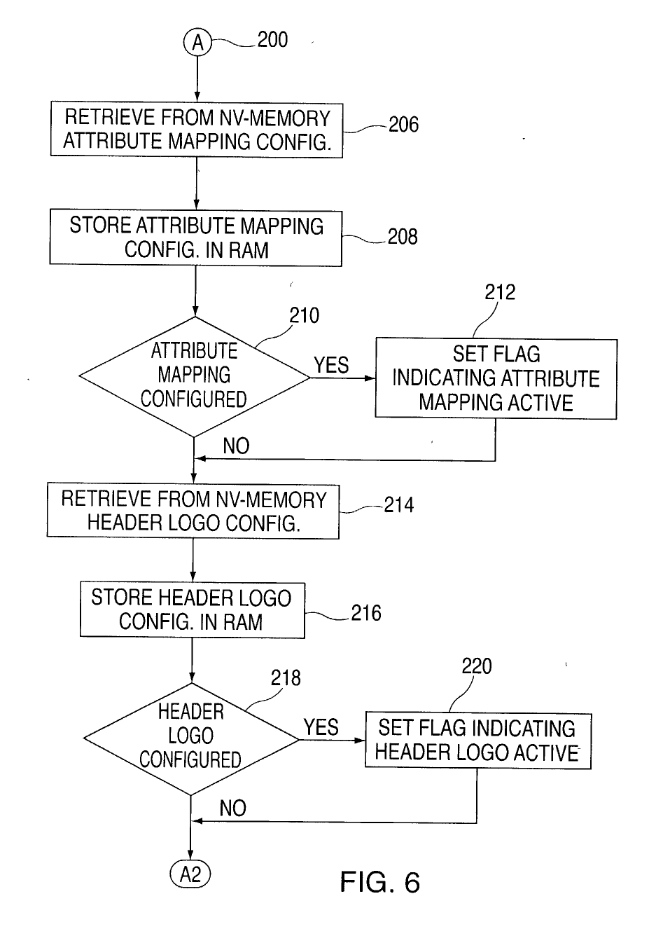

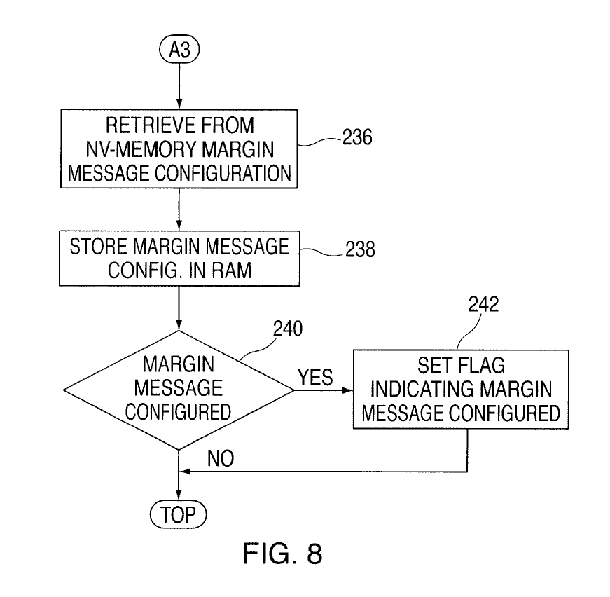

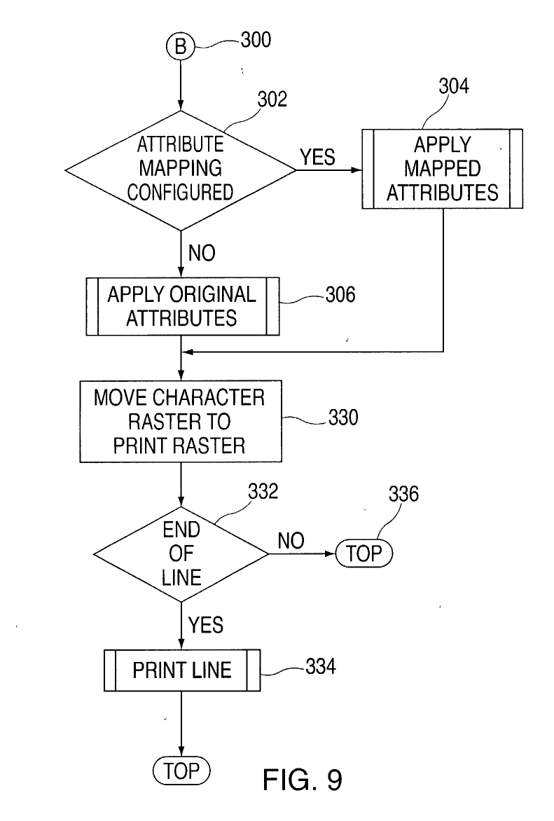

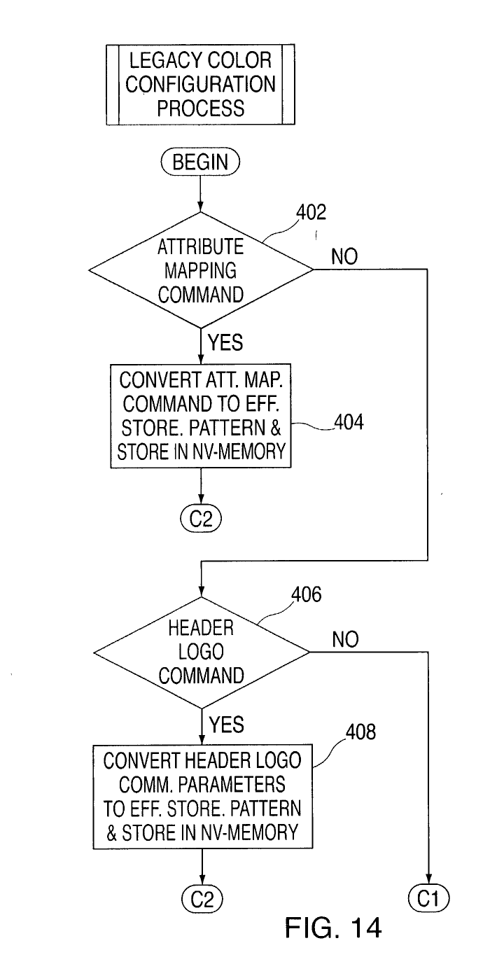

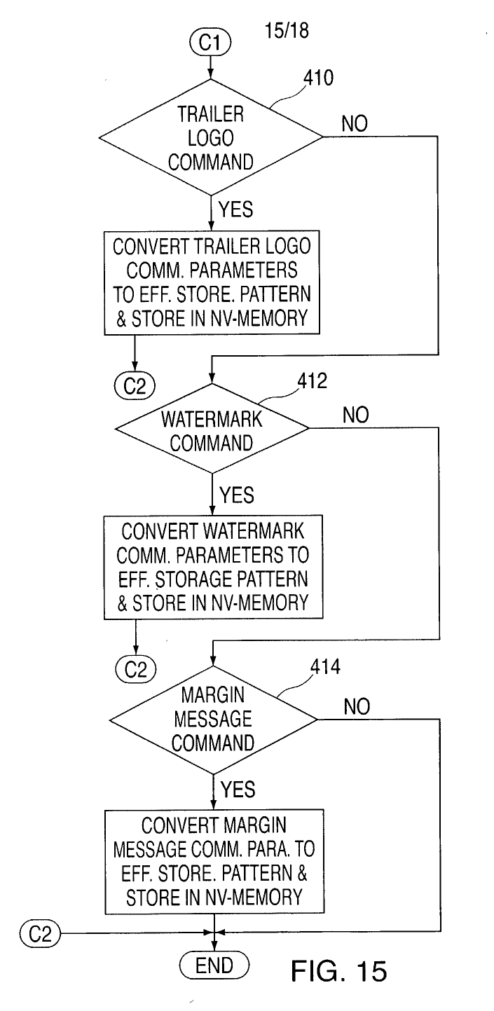

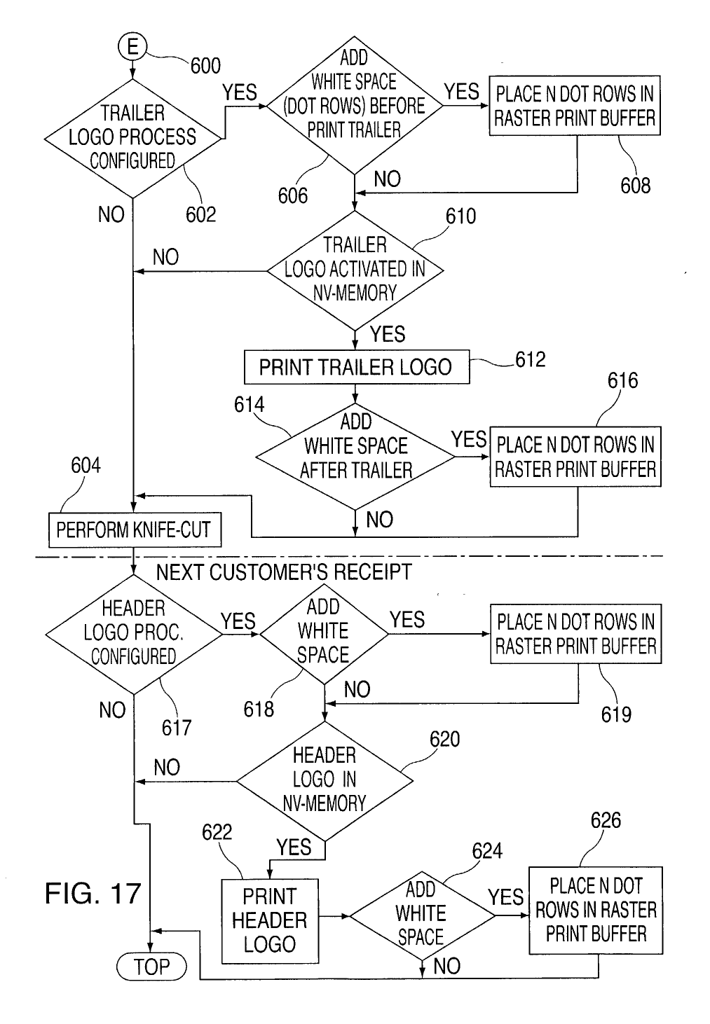

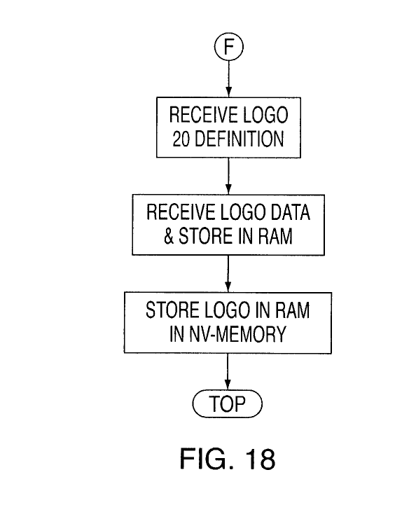

FIG. 4 is a high level flow chart illustrating the process involved to accomplish the alternative printing options made available through use of the present invention. As previously stated, the present invention is implemented in commands embedded in firmware resident in a transaction printer, such as a POS printer, an ATM, a kiosk, or the like, designated generally by reference numeral 10. FIG. 5 is an intermediate level flow chart of the process, and FIGS. 6-18 are intermediate level flow charts of each of the commands and configuration processes associated with the present invention, as will be described hereinafter.

Referring to FIG. 5, an intermediate level flow chart illustrating the present invention is shown. After power is applied to printer, step 100, it is initialized in step 102. Once initialized 102, the printer enters a main loop 104 that will continue until the printer is powered down. Within main loop 104, the printer is instructed to check for various actions to take place, as will be described in greater detail hereinafter. Each separate action that the printer may take will cause it to execute a different path represented generally by reference numerals 200, 300, 400, 500, 600, and 700, but always returning to the main loop 104. For purposes of describing the various actions in general, the initialization path 200 describes the act of retrieving legacy graphics and attribute mapping parameters from non-volatile memory, and storing the parameters in a RAM resident within the printer (RAM is used as it has been found to be an efficient and faster type of memory for reading from and writing to). Paths 400 and 700 represent configuration parameters stored in, the printer's non-volatile memory. The configuration parameters are “sent” to the printer via the commands described hereinafter, and this can be implemented using a software utility, such as the one marketed under the trademark LOGOEZ provided by Axiohm Transaction Solutions, Inc., of Ithaca, N.Y., or any equivalent user interface designed to provide users with a tool to perform tasks, such as designing logos and configuring a printer. Paths 300, 500, and 600 each relate to applying legacy graphics and attribute mapping parameters in order to cause the printer to print the desired output on a receipt, as described further below.

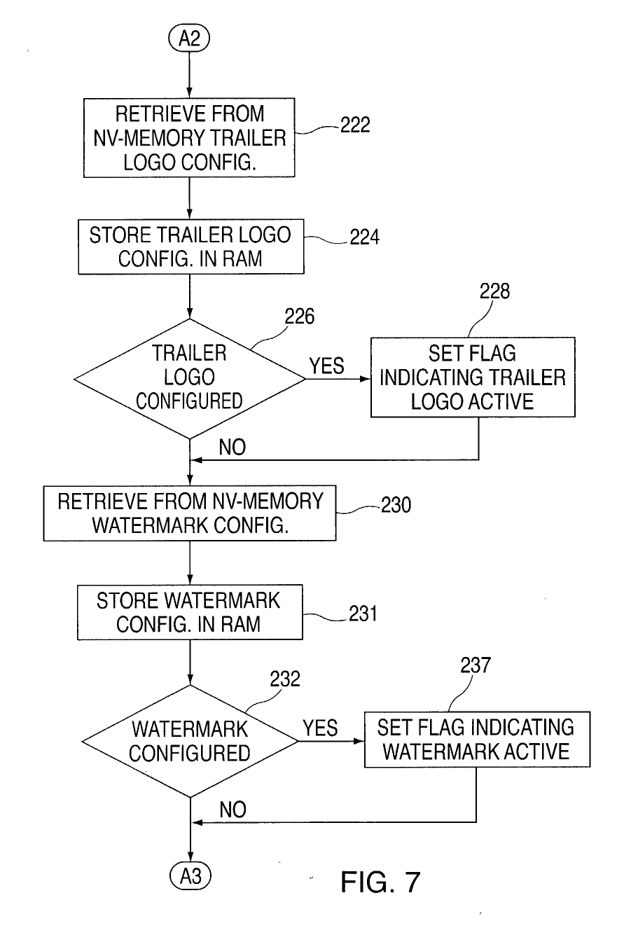

Referring specifically to FIGS. 6-8, the initialization process 200 is illustrated. During initialization, the printer first retrieves from non-volatile memory the attribute mapping configuration 206, and then stores the attribute mapping configuration in RAM for efficient real time use 208. The initialization process then determines whether attribute mapping has been configured, step 210. If attribute mapping has been configured, a flag is set indicating that attribute mapping is active, 212. If attribute mapping has not been configured, or following the setting of the flag in step 212, the printer then retrieves header logo configuration data from the non-volatile memory, 214. The header logo configuration data is then stored in RAM (for efficient real time use) step 216, or alternatively, the data could remain in non-volatile memory 14 for retrieval (as could all the data; the best mode, however, is believed to be to transfer the data to RAM). If the header logo data is configured, step 218, then a flag is set indicating this fact, step 220. If the header data is not configured, then the printer 10 simply retrieves the trailer logo configuration from non-volatile memory, step 222 (see FIG. 7).

Once the trailer logo configuration is retrieved from non-volatile memory 14, it is stored in RAM, 224, and the printer then determines whether the trailer logo has been configured, 226. If the trailer logo has been configured, then a flag is set to so indicate, 228. If the trailer logo has not been configured, or following the setting of the flag, 228, the printer then retrieves the “watermark” configuration from non-volatile memory (“watermark” simply being a less dense bitmap file (compared to a typical graphic image), thereby creating a more transparent image), 230 and it is stored in RAM 231. If the watermark is configured, 232, then a flag is set indicating the watermark as being active, step 234, and if not, then printer retrieves the margin message configuration from non-volatile memory, 236.

Once the margin message configuration is retrieved, it is stored in RAM, 238. The printer then determines whether the margin message has been configured, 240, and if so, then a flag is set to so indicate, 242. If the margin message is not configured, or following setting of the flag, 242, the printer then returns to main loop 104.

This initialization process 200 is done while printer 10 is powered up or reset. After the initialization process 200 is completed, printer 10 is configured to be capable of merging and printing various logos as headers, trailers, watermarks, and/or in the side margins together with the transaction text, and substituting predetermined attributes for original attributes of the text. The remainder of the process and system describes how printer 10 does merge and print the logos and mapped attributes on a receipt.

Once in the main loop 104, printer 10 first determines whether there is any data in the print buffer, step 106. If there is no data in the print buffer, the printer simply returns to the main loop 104, continuing in this fashion until data is present. If there is data present in the buffer, then it is determined whether it is printable data (i.e., whether the data is 20 (hex) or greater), step 108. If it is printable data, then attribute mapping configuration 300 is applied. If the received data is command data (i.e., not printable data, or less than 20 (hex)), then the commands are processed, as described in greater detail hereinafter.

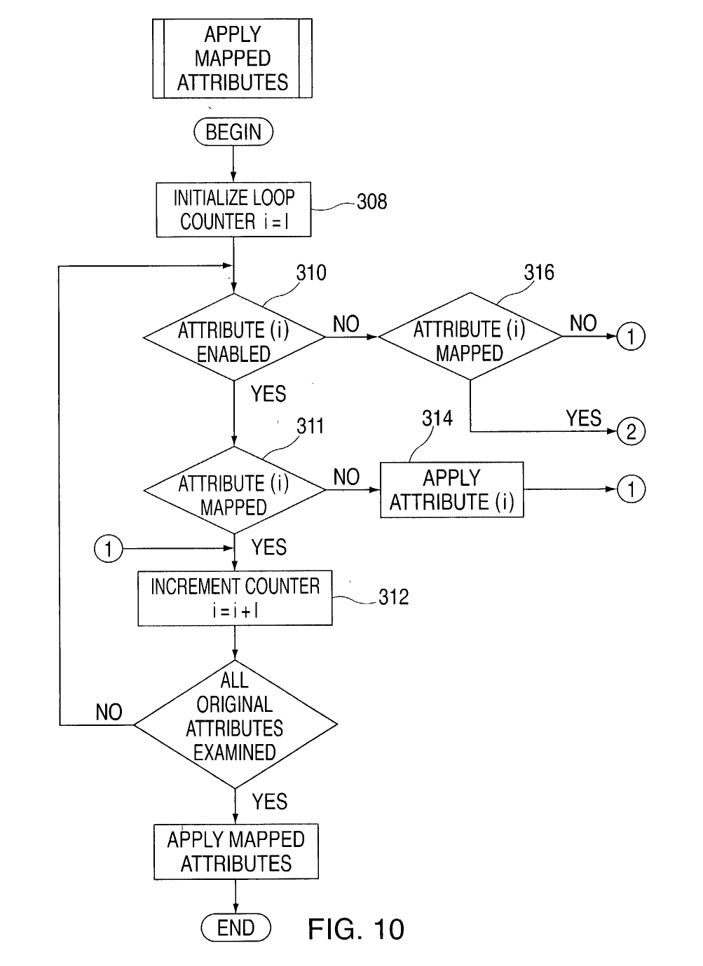

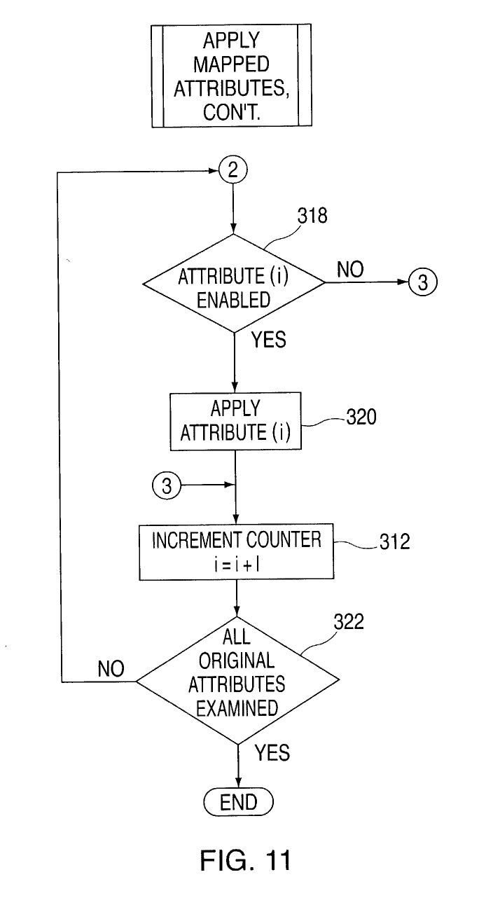

Attribute mapping 300 first determines whether the attribute mapping has been configured, 302, and if it has, then the mapped attributes are applied, 304. If attribute mapping has not been configured, then the original (default) attributes are applied, 306. To apply mapped attributes, reference is made to FIGS. 10 and 11. Applying mapped attributes 304 begins by starting a loop counter 308 (i.e., i=1), and then determining whether attribute (i) has been enabled, 310. If attribute (i) has been enabled, then it is determined whether attribute (i) has been mapped, 311. If attribute (i) has not been mapped, the attributes are applied and the counter increments, 312, (i.e., i=i+1). If attribute (i) has been mapped, the mapped attribute is applied, 314, and then counter 312 increments. If the attribute has not been enabled in step 310, then the printer determines whether the attribute has been mapped, 316. If the attribute has not been mapped, then the counter 312 simply increments. If the attribute (i) has been mapped, then the printer determines whether attribute (i) has been enabled 318 (FIG. 11). If attribute (i) has not been enabled, then counter 312 increments. If attribute (i) has been enabled, then mapped attribute (i) is applied, 320. After counter 312 increments, the printer then determines whether all original attributes have been examined, 322. If all attributes have been examined, then this part of the process ends, and returns to the main loop, 104. If all attributes have not been examined, then the above process repeats itself, and this continues until all mapped attributes have been examined (i.e., i=the total number of original attributes), at which point this part of the process ends and returns to the main loop 104.

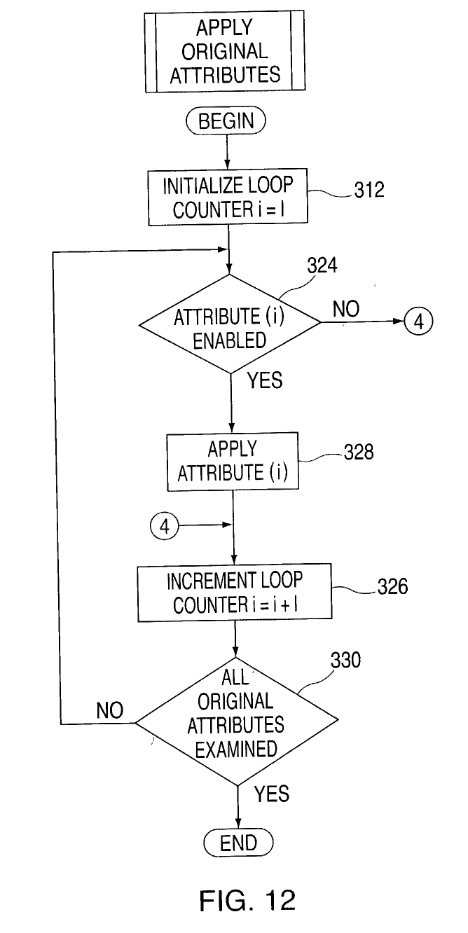

If original attributes are to be applied from step 302, reference is then made to FIG. 12. If original attributes are to be applied, attribute counter 312 starts (i.e., i=1) and then the printer determines whether this attribute is enabled, 324. If the attribute is not enabled, counter 312 increments, 326, and the process continues. If the attribute is enabled, then the printer applies the attribute, 328, and then the counter increments, 326. After incrementing the counter, 326, the printer determines whether all attributes have been examined, 330, and if so the process ends. Otherwise, the process continues with step 324 until all original attributes have been examined.

Once all attributes have been examined, the data is moved to the print raster 330, and printer 10 checks to determine whether the raster is at the end of a line, 332. If it is at the end of the line, it prints the line 334, and if not, it returns to processing data, 336.

Although the above logically describes attribute mapping process 300, physically the printer 10 is streaming the text data that is simultaneously applying the mapped attributes to those original attributes for which a mapping has been enabled, and then storing the data with or without the mapped and/or original attributes in the raster print buffer.

Referring again to FIG. 5, once the attribute mapping process 300 has completed, main loop 104 is entered, and the printer determines whether there is data in the receive buffer 106, and if so, whether it is printable data 108. Assuming there is no new printable data in the receive buffer, and that there is command data in the buffer, then the logical progression of the present invention next involves parsing the commands 110 for execution. The parsed commands include the legacy graphics commands 112, the print command 114, the knife-cut command 116, the down load logo command 118, and perhaps other commands 120, as contained in environment box 122. The print command 114 and knife-cut command 116 are conventional commands that are used by the present invention to trigger the new commands.

Configuring the printer 10 for legacy graphics, 400, actually occurs during printer down-time (i.e., when the printer is in operation, but not in an operable environment, or during initialization), and comprises two parts: a utility program, such as LOGOEZ program described hereinabove, for performing specific tasks such as creating customized graphics/logos, and firmware embedded in printer 10 that converts the legacy graphics and mapping attribute commands into a form suitable for storage in non-volatile memory, and stores the data in non-volatile memory.

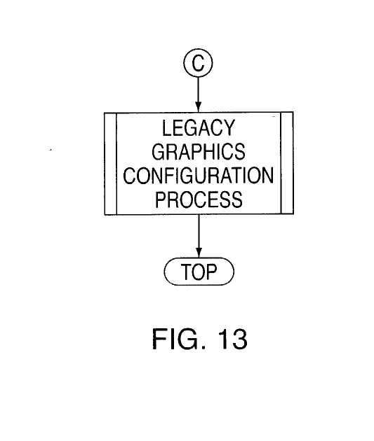

The conversion and storage of the colorization commands is progressively illustrated in FIGS. 13-15. The conversion process begins by determining whether there is any attribute mapping commands stored in memory, 402. If there are attribute mapping commands present, these command parameters are converted to an efficient storage pattern and stored in non-volatile memory, 404. If no attribute commands are present, the conversion process then determines whether there is any legacy graphics commands present. If there are legacy graphics commands (i.e., configurations for header logos 406, trailer logos 410, watermarks 412, and/or margin messages 414) present, the command parameters are converted to efficient storage patterns and stored in non-volatile memory, 408. This same process continues as other commands (i.e., trailer logo commands 410, watermark commands 412, margin message commands 414) are searched for and converted for storage in, non-volatile memory if present.

Referring once again to FIG. 5, after legacy graphics configuration 400 has been accomplished and there are no other graphics commands to process, main loop 104 is once again entered and it will be assumed that there is still command data remaining in the receive data buffer, thereby continuing the command process.

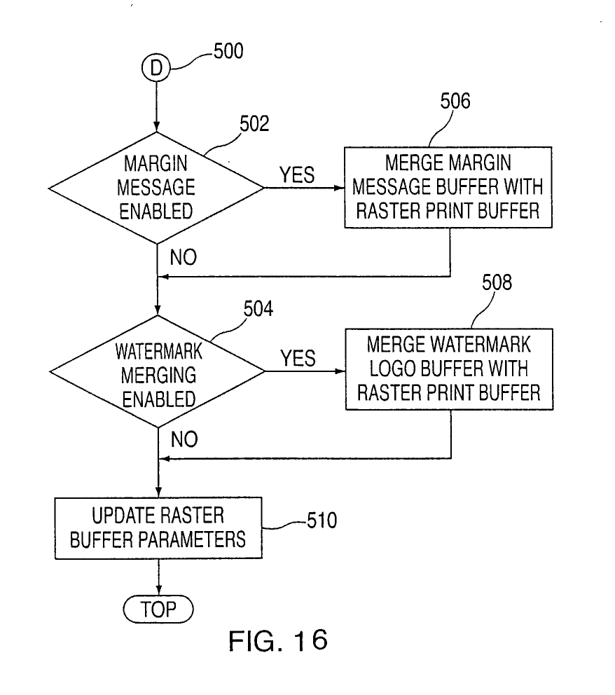

The next step in the process is for printer 10 to determine whether a print command has been sent, 114 (i.e., determine whether there is printable transaction data in the print raster buffer of the printer). Referring to FIG. 16, if a print command is present, then the printer will check to see if a margin message, 502, or a watermark command, 504, is enabled. If a margin message is enabled, then the margin message buffer is merged with print raster buffer 506. If a margin message is not enabled, or following merging of the margin message buffer with the print raster buffer, the printer determines whether the watermark logo is enabled, 504, and if so merges the watermark logo buffer with the print raster buffer 508. The raster buffer parameters are then updated for printing purposes, 510, and the process continues back to the main loop 104.

The printer next determines whether a knife cut command has been issued 116. If a knife cut command is present, the present invention processes the legacy graphics commands for header and trailer configurations pursuant to step 600. Once a knife cut command is detected, the printer first determines whether a trailer logo has been configured, 602. If no trailer logo has been configured, the knife cut is simply executed, 604. If trailer logo has been configured, then the printer determines whether “white space” (i.e., blank dot rows) needs to be added below the printed text, 606. If white space is necessary, (n) dot rows will be added to the raster print buffer, 608. If no white space is needed, or following the addition of (n) dot rows to the print raster buffer, the printer determines whether the trailer logo has been configured in non-volatile memory, 610. If the trailer logo has not been configured, the knife cut is performed, 604, but if it has been activated, then the trailer logo is printed, 612. After the trailer logo has been printed, the printer determines whether a predetermined number (n) of dot rows of white space is needed, 614, and if so, (n) rows are added to the print raster buffer 616. If no rows are needed or following the (n) dot rows being added to the buffer, the knife cut is preformed, 604, and the receipt is handed to a customer containing the attributes and logos described hereinabove, in addition to the transaction text.

Once the receipt has been cut, the printer automatically checks to determine whether any header logo has been configured, 617. If no header logo command is present, the printer returns to main loop 104 and waits for print data to be sent to it. If header logo is present, then the printer determines whether any white space is needed at the top of the receipt, 618. If white space is needed, a predetermined number of dot rows are added to the print raster buffer 619, and the printer then checks to determine whether the header logo command has been activated in non-volatile memory, 620. If a header logo has been enabled, then the header logo is printed, 622, and the printer determines whether a predetermined number of dots rows (white space) is requested to be added beneath the header logo, 624. If white space is requested, it is added, 626, and if no white space is requested, the printer stops processing and returns to main loop 104 and waits for printable data to be processed, at which point the above described procedures are repeated.

It should be pointed out that the various steps of the invention described above may be processed in parallel, rather than serially, despite the logical progression of steps, and the software enabling the functionality is resident in the printer (as firmware), as opposed to residing in a host which remotely communicates with networked printers, thereby eliminating the need to modify the host if the foregoing functionality needs to be changed, added, deleted, or otherwise addressed on any particular printer.

A general description of the two commands and their associated parameters that achieve the functionality described above are as follows:

Command: Legacy Graphics: 1F 03 16 f s r t

Parameters:

f is a function selector, which also defines how many following parameters are used:s=spacing (top/bottom) distance, r=repetition space distance, t=side margin message toggle mode

f=0 turn off all legacy colorization functions (default). No other parameters are required.

f=1 Link Print logo after knife cut—this is equivalent to printing a transaction header graphic. Print logo F0h after any knife-cut using s mm spacing after the logo (1F 03 16 01 s).

After executing any knife-cut command, if the logo at F0h is currently defined and s>0 then execute this sequence of actions:

suspend background merging mode (=1D 9B 1 command) saving previous mode value, so the logo will print in the clear

set centered justification (=1B 61 1 command) saving the previous justification

print the logo at index F0h-execute Print Downloaded Bit Image, normal size (=1D 2F 0 command)—without changing the value of Current Logo.

reset justification to previous value (=1B 61 [previous value])

skip (feed paper) s mm (=15s*8 command),

restore background merge suspension (=1D 9B [previous value]).

Since there already is about 18 mm of space after the knife cut on a conventional transaction printer, no extra space is added to the logo top. S=0 is the default value and turns off the f=1 action (logo after knife-cut link.)

f=2 Link Watermark printing. Activate watermark mode using logo F1h (1F 03 16 02 s r). S is the skip distance in mm before activation and r is the distance in mm between watermark repetitions.

After any knife-cut command and f=1 actions, if a logo is currently defined at index F1h and complies with watermark mode requirements and s>0 then execute this sequence of actions:

skip s mm (=15 s*8 command),

set watermark mode on using logo F1h (=execute Merge Watermark Mode-1D 8C r F1 command.)

suspend background merging mode (=1D 9B 1 command), so any logos, barcodes, and captured images will print in the clear

if no f=4 link is defined, then set a null trailer logo with s=18 mm (=1F 03 16 04 12) so that watermarks are off at the position a knife cut would occur. This leaves a clear space at the top of the next receipt.

This turns watermarks on (after an optional F0h logo) and restarts watermarks after each knife cut. Note that the suspension of merging when printing graphic objects is turned on by each knife cut. S=0 is the default value and turns off the f=2 linked actions.

f=3 Link margin message printing. Activate sidebar margin message printing mode using logo F2h (1F 03 16 03 s r t). S is the skip distance, r the distance between repetitions, and t the toggle mode.

The toggle mode values t are:

t=0 both left and right side

t=1 toggle sides, starting with left side

t=2 toggle sides, starting with right side

t=3 left side margin message only

t=4 right side margin message only

After any knife cut and f=1 action, turn on margin message graphics using the logo at index F2h if it is defined and s>0 by executing the following sequence:

skip s mm (=15 s*8 command) Note if both watermark and margin message merging are defined, only one should have a normal s value, and the other s=1.

Apply margin message Graphics Mode for left and right side as needed by the toggle mode, up to both sides (=1D 99 1 F2 50 0 command followed by the 1D 99 2 F2 50 t command.)

suspend background merging mode (=1D 9B 1 command), so any logos, barcodes, and captured images will print in the clear

if no f=4 link is defined, then set a null trailer logo with s=18 mm (=1F 03 16 04 12) so that watermarks are off at the position a knife cut would occur. This leaves a clear space at the top of the next receipt.

This will turn margin message printing on after the header logo with a restart at each knife-cut. Note that the suspension of merging when printing graphic objects is turned on by each knife cut.

f=4 Link logo print before cut. Prints a logo after a skip distance s and then automatically advances to have a complete logo at the knife cut (trailer printing, 1F 03 16 04 s).

Immediately before executing any knife-cut command, if a logo at index F3h is currently defined and s>0 then execute this sequence of actions:

skip (feed paper) s mm (=15 s*8 command),

suspend background merging mode (=1D 9B 1 command) saving previous mode value, so the logo will print in the clear

set centered justification (=1B 61 1 command) saving the previous justification

print the logo at index F3h—execute Print Downloaded Bit Image, normal size (=1D 2F 0 command)—without changing the value of Current Logo.

reset justification to previous value (=1B 61 [previous value])

skip (feed paper) 18 mm (=15 90 command), so that the knife cut will occur on paper after the logo

restore background merge suspension (=1D 9B [previous value]).

Description: This command configures into non-volatile memory 14 (permanent configuration switch setting) a conglomerate mode of operation that provides for header color logo printing, full-time side margin message printing, full-time middle-of-receipt watermarking, and trailer color logo printing; all triggered by any knife-cut command. Power-up immediately executes header, watermark, and margin message actions if set, leaving the printer in a state ready to print the body of a receipt.

For any selected actions to take place, logos with index vales F0h, F1h, F2h, F3h respectively must have been defined and saved in non-volatile memory. Note that if the knife (or other separator) is a short distance above the print head, and applications usually account for this by sending paper feed commands before issuing the cut. Thus in the trailing logo case (f=4) there is an automatic skip of 18 mm to prevent cutting into the end of the logo. Also, if watermarks and/or margin message logos are configured, the suspension of background merging on graphics objects must be explicitly defeated by the application if that is not the desired behavior.

Since this command's setup action takes place at configuration level, it is unaffected by any choices in emulation; thus the actions chosen will occur irrespective of the emulation to which the printer has configured.

Command: Legacy Attribute Mapping: 1F 03 17 a m s

Parameters:

a is the attribute map selector

a, m, s=0, 0, 0 turn off attribute mapping (all 3 bytes required)

a=1 selects the first (of two) attribute mapping definition

a=2 selects the second attribute mapping definition

for a=1 or 2 if m=0 then mapping 1 or 2, respectively, is turned off

A word (2 bytes) is used to identify the attribute mapping:

m bits 0-6 identify which original attributes should be mapped

m bit 0 on: Bold original

m bit 1 on: Italic original

m bit 2 on: Reverse original

m bit 3 on: Underline original

m bit 4 on: Double high original

m bit 5 on: Double wide original

m bit 6 on: Compressed print original

s bits and m bit 7 identify which attributes substitute for the mapped set:

m bit 7 on: Bold substituted

s bit 0 on: Italic substituted

s bit 1 on: Reverse substituted

s bit 2 on: Underline substituted

s bit 3 on: Double high substituted

s bit 4 on: Double wide substituted

s bit 5 on: Compressed print substituted

s bit 6 on: Alternate color substituted

s bit 7 on: Color reverse substituted

The operation is: if (input char attributes) AND (original)=(original) then (output char attributes)=((original) XOR (input char attributes)) OR (substituted). Map the input character's original attributes to the substituted ones, preserving any that were on but not specified for mapping.

Description: This command configures into non-volatile memory 14 (configuration switch setting), one or two combinations of character attribute mappings, with the substitute attribute set including color effect choices. At the time a character code is evaluated for placement into the raster print buffer, its attributes are used to form the desired pixel character. If the on attributes match the attribute mask m then they are mapped to the attributes specified in attribute substitution s. If m=0 then no substitution takes place.

Since this command's setup action takes place at configuration level, it is unaffected by any choices in emulation; thus the actions chosen will occur irrespective of the emulation to which the printer has been configured.

The above description of the command and parameter structures are for illustrative purposes only, and the spirit and scope of this patent should not be limited thereby, but should instead extend to its full scope and spirit as defined by the appended claims.

What is claimed is:

1. A transaction printer for generating and cutting a receipt, said transaction printer comprising:
a. firmware containing an instruction set embedded therein and housed within said transaction printer;
b. circuitry for processing said instruction set, printable text data and original attributes associated with said printable text data; and
c. a first command in electronic communication with said circuitry for mapping predetermined attributes in substitution for said original attributes.

2. The transaction printer of claim 1, further comprising a second command in electronic communication with said circuitry for merging at least one predetermined graphic image with said printable text data.

3. The transaction printer of claim 2, wherein said at least one predetermined graphic image comprises a watermark positioned on said receipt in overlying relation to said printable text data.

4. The transaction printer of claim 3, wherein said graphic image of said watermark is repeated on said receipt in overlying relation to said to said printable text data.

5. The transaction printer of claim 2, wherein said at least one graphic image comprises a margin message logo positioned on said receipt in non-interfering relation to said printable text data.

6. The transaction printer of claim 5, wherein said graphic image of said margin message is positioned along at least one edge of said receipt.

7. The transaction printer of claim 5, wherein said graphic image of said margin message is positioned along each of the opposing side edges of said receipt

8. The transaction printer of claim 5, wherein said graphic image of said margin message is repeated on said receipt, and positioned along at least one edge of said receipt.

9. The transaction printer of claim 5, wherein said graphic image of said margin message is repeated on said receipt, and positioned along each of the opposing side edges of said receipt.

10. The transaction printer of claim 2, wherein said predetermined graphic image is positioned as a header on the receipt.

11. The transaction printer of claim 2, wherein said graphic image is positioned as a trailer on the receipt.

12. A transaction printer for generating and cutting a receipt, said transaction printer comprising:
a. firmware containing an instruction set embedded therein and housed within said transaction printer;
b. circuitry for processing printable text data and original attribute commands associated with said printable text data; and
c. a first command in electronic communication with said circuitry for merging at least one predetermined graphic image with said printable text data.

13. The transaction printer of claim 12, wherein said at least one predetermined graphic image comprises a watermark positioned on said receipt in overlying relation to said printable text data.

14. The transaction printer of claim 13, wherein said graphic image of said watermark is repeated on said receipt in overlying relation to said to said printable text data.

15. The transaction printer of claim 12, wherein said at least one graphic image comprises a margin message positioned on said receipt in non-interfering relation to said printable text data.

16. The transaction printer of claim 15, wherein said graphic image of said margin message is positioned along at least one edge of said receipt.

17. The transaction printer of claim 15, wherein said graphic image of said margin message is positioned along each of the opposing side edges of said receipt

18. The transaction printer of claim 15, wherein said graphic image of said margin message is repeated on said receipt, and positioned along at least one edge of said receipt.

19. The transaction printer of claim 15, wherein said graphic image of said margin message is repeated on said receipt, and positioned along each of the opposing side edges of said receipt.

20. The transaction printer of claim 12, wherein said predetermined graphic image is positioned as a header on the receipt.

21. The transaction printer of claim 12, wherein said graphic image is positioned as a trailer on the receipt.

22. A transaction printer for generating and cutting a receipt, said transaction printer comprising:
a. firmware containing an instruction set embedded therein and housed within said transaction printer;
b. circuitry for processing printable text data and original attribute commands associated with said printable text data; and
c. means for mapping predetermined attributes in substitution for said original attributes of said printable text data.

23. The transaction printer of claim 22, wherein said mapping means comprises a first command in electronic communication with said circuitry.

24. The transaction printer of claim 22, further comprising means for merging at least one predetermined graphic image with said printable text.

25. The transaction printer of claim 24, wherein said means for merging at least one predetermined graphic image with said printable text data comprises a second command in electronic communication with said circuitry.

26. A transaction printer for generating and cutting a receipt, said transaction printer comprising:
a. firmware containing an instruction set embedded therein and housed within said transaction printer;
b. circuitry for processing printable text data and original attribute commands associated with said printable text data; and
c. means for merging at least one predetermined graphic image with said printable text data.

27. The transaction printer of claim 26, wherein said means for merging at least one predetermined graphic image with said printable text data comprises a first command in electronic communication with said circuitry.

28. A method for instructing a transaction printer to generate and cut a receipt containing transaction text, comprising the steps of:
a. initializing mapping attributes to be mapped in place of original attributes associated with the transaction text;
b. storing said mapping attributes in non-volatile memory resident in the transaction printer;
c. applying the mapping attributes in response to receiving original attributes associated with said transaction text; and
d. printing the receipt containing the transaction text with the mapping attributes.

29. The method of claim 28, comprising the further step of electronically communicating a first command to processing circuitry for merging at least one predetermined graphic image with the transaction text.

30. The method of claim 29, comprising the further step of merging said at least one graphic image with said transaction text.

31. A method for instructing a transaction printer to generate and cut a receipt containing transaction text having original attributes associated therewith, comprising the steps of:
a. configuring predetermined mapping attributes in non-volatile memory;
b. electronically communicating a first command to processing circuitry for mapping said predetermined attributes in substitution for said original attributes; and
c. receiving transaction text data.

32. The method of claim 31, further comprising the step of printing said at least one graphic image with said transaction text.

33. The method of claim 32, further comprising the step of printing said at least one graphic image as a watermark superimposed with the transaction text.

34. The method of claim 32, further comprising the step of printing said at least one graphic image as a header on the receipt.

35. The method of claim 32, further comprising the step of printing said at least one graphic image as a trailer on the receipt.
